(19) United States
(12) Patent Application Publication
(10) Pub. No.: US 2008/0312804 A1
(43) Pub. Date: Dec. 18, 2008

(54) Fuel injection control apparatus for engine

(75) Inventor: Naoaki Yanagisawa, Kanagawa-ken (JP)

Correspondence Address: RADER FISHMAN & GRAUER PLLC, LION BUILDING, 1233 20TH STREET N.W., SUITE 501, WASHINGTON, DC, 20036, US

(73) Assignee: NIKKI CO., LTD., Atsugi (JP)

(21) Appl. No.: 12/078,838

(22) Filed: Apr. 7, 2008

(30) Foreign Application Priority Data
Jun. 15, 2007 (JP) 2007-158146

(51) Int. Cl. F02D 41/30

(52) U.S. Cl. 701/103

(57) ABSTRACT

A fuel injection control apparatus for an engine which carried out a fuel injection control according to a speed density system which estimates an intake air amount from detected engine rotational speed value and intake pipe pressure value to decide a fuel injection amount, the control apparatus preventing an air fuel ratio from becoming lean due to clogging of an air cleaner, by calculating an intake pipe pressure differential pressure value between an intake pipe pressure average value and an intake pipe pressure minimum value which are continuously detected, and by correcting the fuel injection amount according to a predetermined procedure while using the differential pressure value of the intake pipe pressure.

### BACKGROUND OF THE INVENTION

1. Field of the Invention

The present invention relates to a fuel injection control apparatus for an engine, and more particularly to a fuel injection control apparatus for an engine, which carries out a fuel injection control according to a speed density system.

2. Description of Related Art

In a fuel injection control for an engine, one typical control system has come in wide use in which a fuel injection amount is decided for achieving an optimum air fuel ratio according to an intake air amount which is detected by an air flow sensor. On the other hand, in a general purpose engine which is comparatively simple in its structure and is generally small in its size, there has been frequently employed a speed density type injection control system which decides a fuel injection amount by estimating an intake air amount from a value of an engine rotating speed and a pressure value prevailing in an intake pipe, for the reason that the air flow sensor is a comparatively expensive unit and in addition generates a resistance against the flow of an intake air, as described in Japanese Laid-open (Kokai) Patent Application Publications Nos. 60-156946 and 5-240105.

It is often the case that the general purpose engine employing the above-mentioned fuel injection control system is used under a condition that a dust or a minute foreign matter is mixed into an intake air, for example, the case that the general purpose engine is employed for use in a lawn mower. Accordingly, the dust or the foreign matter clogs in an air cleaner provided in an inlet side of an intake air pipe line of the engine, there frequently occurs such a trouble as to adversely affect an engine performance. This is because the intake air pipe is choked and an intake air amount is reduced due to a clogging of the air cleaner, and lowering of an engine output occurs.

FIG. 1 is a layout view of a conventional engine system in accordance with the above-mentioned control system. In a case where a speed density system is employed for controlling fuel injection in an engine system in which an intake pipe pressure sensor 12 is arranged only in one cylinder side of a general purpose engine having two cylinders, a pressure prevailing in a section of an air cleaner 2 becomes lower even under a similar intake air amount due to a clogging of the air cleaner 2, and an intake air pressure appearing in the strokes other than the intake stroke becomes lower. Therefore, an average value of the intake air pressure becomes lower in comparison with the case where no clogging occurs in the air cleaner 2.

Accordingly, a calculated air density becomes small and an amount of a fuel injected by injectors 7 and 8 is less calculated. As a result, an air fuel ratio tends to become lean. FIG. 6 is a graphical view illustrating a relation between an intake air pressure and an air fuel ratio in the case of preparing in a simulated manner a pseudo-clogging condition in which clogging of the air cleaner is prepared by artificially clogging an inlet of the air cleaner. It is known that an air fuel ratio becomes lean in accordance with gradual progress in the clogging of the air cleaner.

### SUMMARY OF THE INVENTION

Therefore, the present invention aims to solve the above-mentioned problem, and an object of the present invention is to provide a fuel injection control apparatus of an engine employing a speed density system for carrying out a fuel injection control, which apparatus can maintain an air fuel ratio in a good state even in the case that an air cleaner is clogged.

In accordance with the present invention, there is provided a fuel injection control apparatus for an engine which carries out control of a fuel injection according to a speed density system which estimates an intake air amount from detected values of an engine rotational speed and an intake pipe pressure to decide a fuel injection amount, wherein the control apparatus carries out the control by preventing an air fuel ratio from becoming lean due to a clogging of an air cleaner, through executing calculation of a differential pressure value of an intake pipe pressure appearing between an intake pipe pressure average value and an intake pipe pressure minimum value which are continuously detected, and correction of the fuel injection amount according to a predetermined procedure while using the differential pressure value of the intake pipe pressure.

Since controlling of the fuel injection amount is carried out in a direction of achieving a proper air fuel ratio proper in response to the differential pressure value of the intake air pressure, by the use of the fact that the differential pressure value of the intake air pressure appearing between the intake air pressure average value and the intake air pressure minimum value becomes smaller than the difference at a normal time due to a progress in the clogging of the air cleaner, it becomes easy to prevent deterioration of the air fuel ratio is apt to be prevented in compliance with the clogging of the air cleaner.

Further, if the correction of the fuel injection amount is performed by deriving a correction coefficient according to the predetermined procedure from the differential pressure value of the intake air pressure appearing between the intake air average value and the intake air pressure minimum value and by multiplying a control value for achieving the corrected fuel injection amount by the correction coefficient, it is easy to achieve a smooth control without applying an excessive process load to the control apparatus.

Further, in this case, if the correction coefficient is derived by applying the above-mentioned difference value to a predetermined numerical expression or a predetermined map for achieving a desired air fuel ratio, it is possible to securely derive the correction coefficient in accordance with a comparatively simple procedure by previously setting the numerical expression or the map on the basis of an experimental data or the like.

In accordance with the present invention characterized in such a configuration that the fuel injection amount is controllably corrected by utilizing the differential pressure value of the intake pipe pressure appearing between the detected intake pipe pressure average value and intake pipe pressure minimum value, it is possible to maintain the air fuel ratio in an appropriate and good state even in the case of clogging of the air cleaner.

### BRIEF DESCRIPTION OF THE DRAWINGS

FIG. 1 is a layout view of an engine system which is in common with an embodiment in accordance with the present invention and a prior art;

FIG. 2 is a flow chart illustrating a control procedure by a fuel injection control apparatus in accordance with the present embodiment;

FIG. 3 is a graphical view illustrating a comparison of a result of control by the fuel injection control apparatus in accordance with the present embodiment with that by the prior art;

FIG. 4 is a graphical view illustrating a comparison of a fluctuation condition of an intake pipe pressure at a normal time with that at a time when an air cleaner is clogged;

FIG. 5 is a graphical view illustrating a comparison of a differential pressure value between an average value and a minimum value of the intake pipe pressure in correspondence to a degree of clogging at a time when the air cleaner is clogged; and

FIG. 6 is a graphical view illustrating a fluctuation of an air fuel ratio in compliance with the degree of clogging at a time when the air cleaner is clogged.

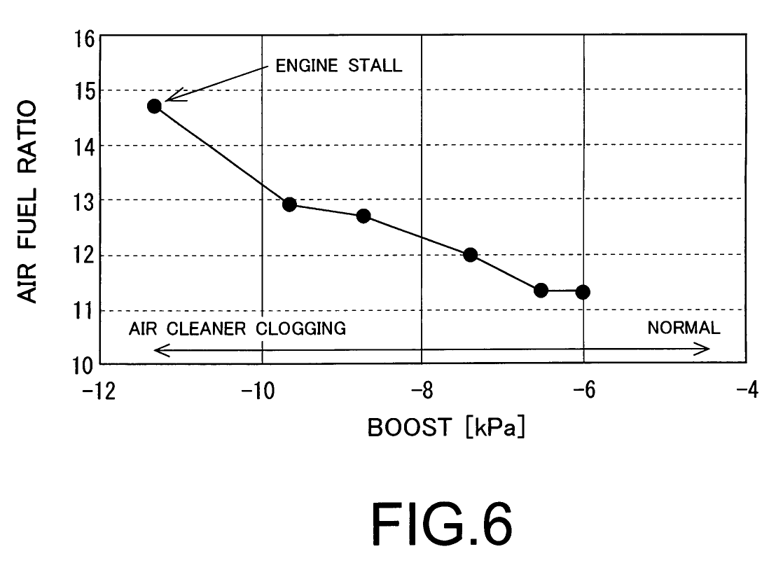

### DESCRIPTION OF PREFERRED EMBODIMENTS

A description of a best mode for carrying out the present invention will be provided below with reference to the accompanying drawings. In this case, in the present invention, correcting a fuel injection amount by using an intake pipe pressure differential pressure value between an intake pipe pressure average value and an intake pipe pressure minimum value includes correcting a control value for outputting an injector drive current achieving the fuel injection amount, in addition to correcting a calculated fuel injection amount by using the intake pipe pressure differential pressure value or a correction value generated by the intake pipe pressure differential pressure value.

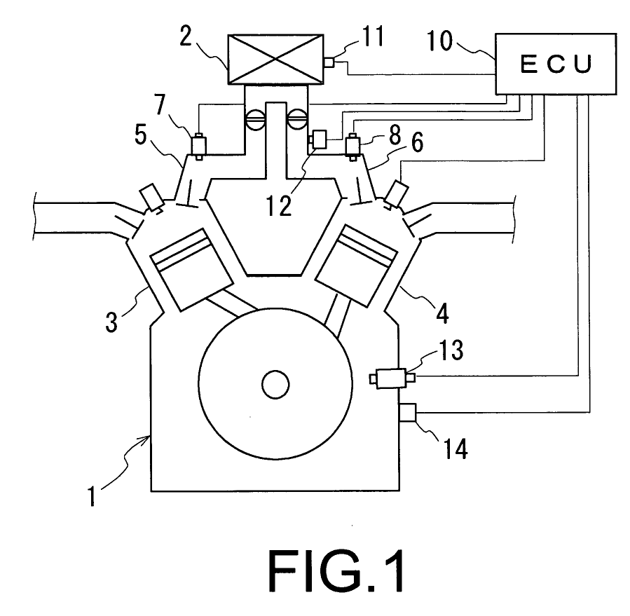

A duel injection control apparatus in accordance with the present embodiment is shown in a layout view of an engine system in which an electronic control unit 10 is arranged, in the same manner as the prior art shown in FIG. 1 mentioned above. An engine 1 is constituted by a general purpose engine having two cylinders, and is structured such that intake pipe lines 5 and 6 extended out of one air cleaner 2 so as to be branched are respectively connected to cylinders 3 and 4, an intake pipe pressure sensor 12 for detecting an intake pipe pressure is arranged in the intake pipe line 6 connected to one cylinder 4, and a detected signal is continuously output to the electronic control unit 10.

Further, a crank position sensor 13 is arranged in the engine 1, and is structured such as to continuously output an engine rotational speed value to the electronic control unit 10. The electronic control unit 10 is structured such as to execute a fuel injection control in accordance with a so-called speed density method of estimating an intake air amount by using detected intake pipe pressure value and engine speed, and deciding a fuel injection amount achieving an optimum air fuel ratio in accordance with a predetermined procedure on the basis of the intake air amount so as to output a drive signal to injectors 7 and 8.

Further, the electronic control unit 10 has the same structure as the general fuel injection control apparatus in a hardware, however, a feature portion of the present invention exists in a content of a fuel injection control method which a control program stored in a memory portion of the electronic control unit 10 executes. In this case, a temperature sensor 11 is arranged in the air cleaner 2 so as to detect an intake air temperature, and an engine temperature sensor 14 is arranged in an engine 1 side so as to detect an engine temperature. Further, the electronic control unit 10 is structured such as to detect the intake air temperature and the engine temperature.

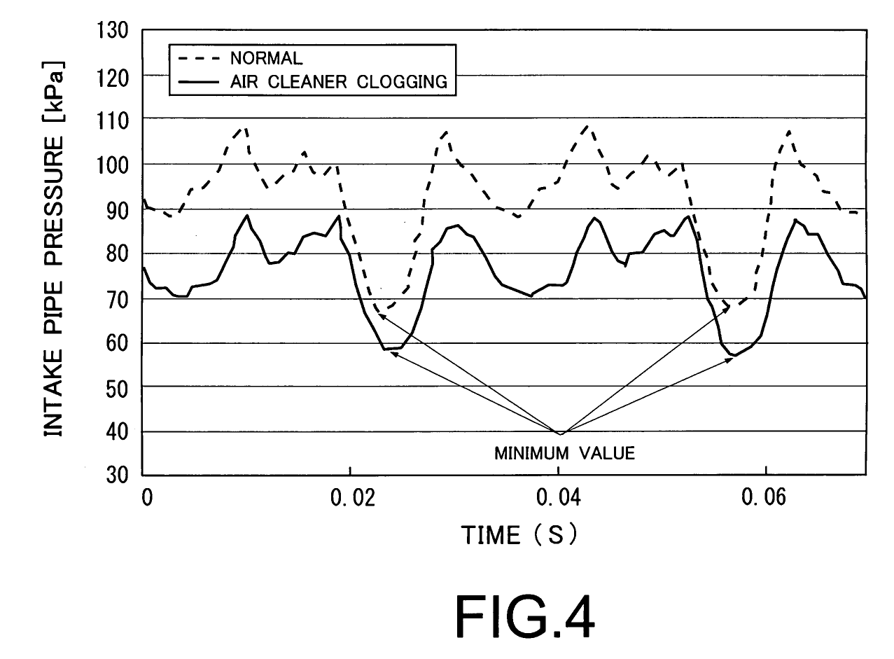

On the basis of a graph in FIG. 4 showing a fluctuation condition of the intake pipe pressure at a normal time and a time when the air cleaner is clogged, in the engine system, it is known that the intake pipe pressure tends to become lower in all the regions at a time when the air cleaner is clogged. Generally, it is considered that the region in which the intake pipe pressure becomes lower corresponds to an intake stroke, however, since the other regions than the intake stroke become lower at a time when the air cleaner is clogged, the calculated intake pipe pressure average value becomes lower, and the intake pipe pressure differential pressure value between the intake pipe pressure average value and the intake pipe pressure minimum value becomes smaller.

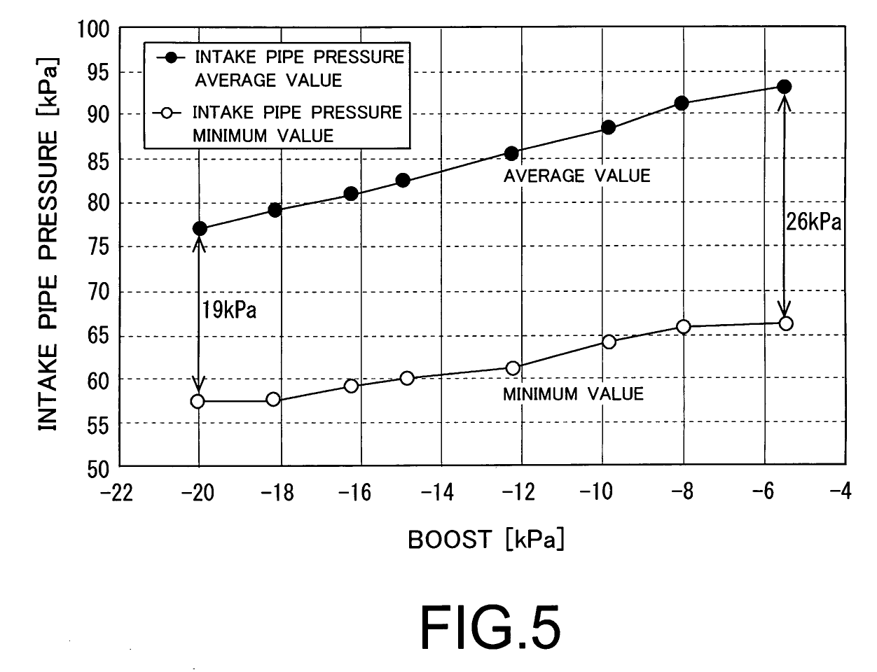

FIG. 5 is a graph showing a relation between the intake pipe pressure average value and the intake pipe pressure minimum value at a time when the air cleaner is clogged. On the basis of this graph, it is known that the intake pipe pressure differential pressure value between the intake pipe pressure average value and the intake pipe pressure minimum value becomes smaller in accordance that the air cleaner 2 is clogged. By utilizing the characteristic, the present invention is characterized by correcting the fuel injection amount at a time when the air cleaner is clogged, on the basis of the intake pipe pressure differential pressure value between the intake pipe pressure average value and the intake pipe pressure minimum value, and executing the fuel injection control achieving the proper air fuel ratio.

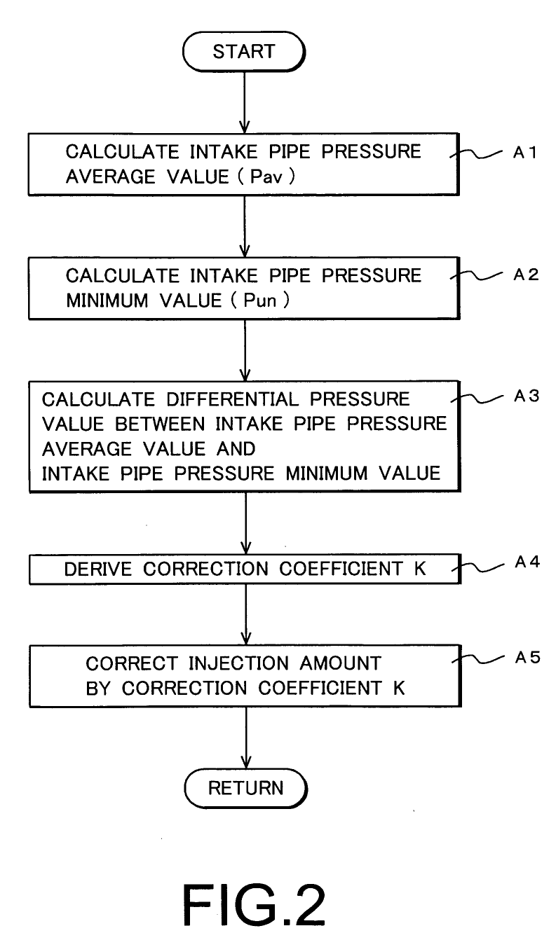

FIG. 2 is a flow chart showing a procedure of the correcting process of the fuel injection amount at a time when the air cleaner is clogged, by the electronic control unit 10 corresponding to the fuel injection control apparatus in accordance with the present embodiment.

If the fuel injection amount correcting process for corresponding to the air cleaner clogging is started under a condition that the fuel injection amount is continuously calculated in accordance with the speed density method, the process determines an intake pipe pressure average value (Pav) on the basis of the detected intake pipe pressure (A1), and determines an intake pipe pressure minimum value (Pun) (A2). Further, the process determines a differential pressure value between the intake pipe pressure average value (Pav) and the intake pipe pressure minimum value (Pun) (A3), and derives a correction coefficient (K) at a time of clogging in accordance with a predetermined procedure by using the differential pressure value (A4). Further, the process corrects the fuel injection amount by using the correction coefficient (K) (A5), and executes a control returning to the start.

As the method of deriving the correction coefficient (K) at a time of clogging, for example, the method determines an air fuel ratio achieved in each of the differential pressure values between the intake pipe pressure average values (Pav) and the intake pipe pressure minimum values (Pun) in correspondence to the degree of the clogging of the air cleaner 2, in accordance with an actual experiment or a computer simulation, in an assumed engine system, and previously prepares a calculation expression or a map for deriving the correction coefficient (K) corresponding to a coefficient for correcting the air fuel ratio to an optimum air fuel ratio.

It is possible to smoothly and securely derive the correction coefficient (K) without applying any excessive process load to the electronic control unit 10, by storing the calculation expression or the map in the memory portion of the electronic control unit 10 and setting the fuel injection program so as to execute the process in accordance with the fuel injection program. In this case, for example, the calculation expression is generally constituted by one function, however, can be comparatively easily determined on the basis of the data obtained by the expression or the like by using a least square method or the like.

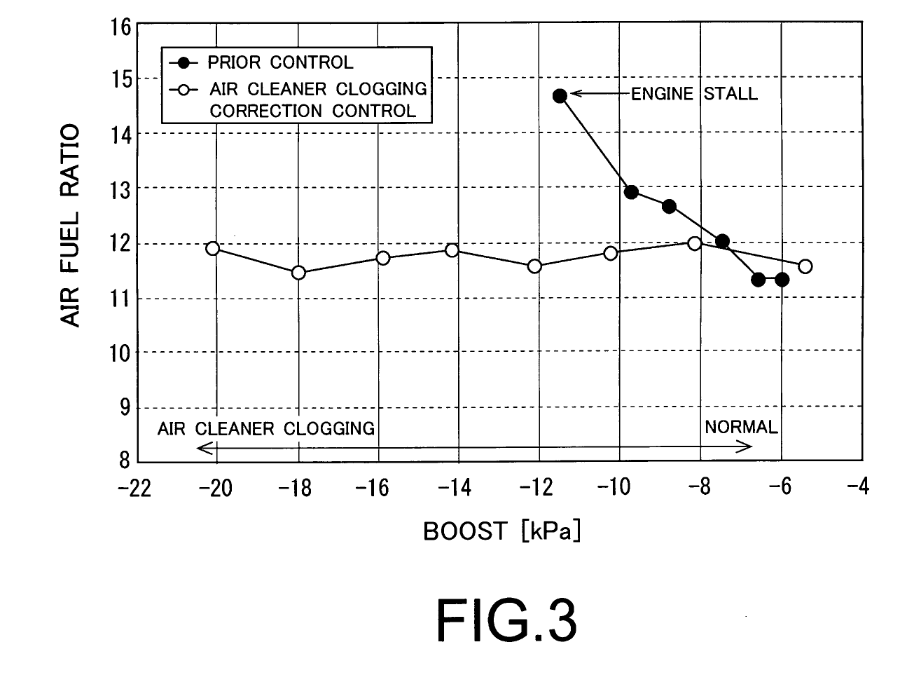

FIG. 3 shows a graph showing a fluctuation of the air fuel ratio in correspondence to a change of the intake air pressure for comparing a result of control of the electronic control unit 10 corresponding to the fuel injection control apparatus in accordance with the present embodiment with that of the fuel injection control apparatus in accordance with the prior art. As is known from the graph, in the control method in accordance with the prior art, the air fuel ratio becomes lean little by little in accordance that the air cleaner 2 is clogged. However, in the control in accordance with the present embodiment carrying out the correction of clogging of the air cleaner, it is known that the air fuel ratio is stable in a level having no problem on an engine operation, even in a condition that the clogging of the air cleaner makes progress (a portion close to a left side of the graph).

As mentioned above, in the fuel injection control apparatus of the engine employing the speed density method for the fuel injection control, the present invention can achieve the air fuel ratio in a good state even in the case that the air cleaner is clogged.

1. A fuel injection control apparatus for an engine which carries out a fuel injection control according to a speed density system which estimates an intake air amount from detected values of engine rotational speed and intake pipe pressure to decide a fuel injection amount, wherein the control apparatus carries out the control by preventing an air fuel ratio from being lean due to a clogging of an air cleaner, through executing calculation of a differential pressure value of an intake pipe pressure appearing between an intake pipe pressure average value and an intake pipe pressure minimum value which are continuously detected, and correction of the fuel injection amount according to a predetermined procedure while using the differential pressure value of the intake pipe pressure.

2. The fuel injection control apparatus as claimed in claim 1, wherein the correction of the fuel injection amount includes performing of a process of deriving a correction coefficient according to the predetermined procedure from the differential pressure value of the intake pipe pressure and multiplying a control value for achieving a controlled fuel injection amount by the correction coefficient.

3. The fuel injection control apparatus as claimed in claim 2, wherein the correction coefficient is derived by applying the difference value of the intake pipe pressure to a predetermined numerical expression or a predetermined map which achieve a desired air fuel ratio.
